(19) United States
(12) Patent Application Publication
(10) Pub. No.: US 2013/0257159 A1
(43) Pub. Date: Oct. 3, 2013

(54) METHOD AND SYSTEM FOR FAST SWITCHING BACKUP POWER SUPPLY IN MULTIPLE POWER SOURCE

(71) Applicants: Long Tian Wang, Nanjing (CN); Shu Yao Zhao, Nanjing (CN)

(72) Inventors: Long Tian Wang, Nanjing (CN); Shu Yao Zhao, Nanjing (CN)

(73) Assignee: Siemens Aktiengesellschaft, Muenchen (DE)

(21) Appl. No.: 13/990,626

(22) PCT Filed: Nov. 28, 2011
(86) PCT No.: PCT/EP2011/071096

§ 371 Date: May 30, 2013

(30) Foreign Application Priority Data
Nov. 30, 2010 (CN) 201010568286.5

(51) Int. Cl. H02J 3/00

(52) U.S. Cl. CPC H02J 3/005
USPC 307/65

(57) ABSTRACT

A method and a system provide fast switching between multiple backup power supplies. The method includes building, on the basis of the changing characteristics of the amplitude difference and phase angle difference of a bus voltage, an acceleration model for the changing speed thereof. An optimum backup power supply is selected from the multiple backup power supplies by way of forecasting the changed value thereof. A load on the bus is switched to the optimum backup power supply. The system contains a detecting module, a calculating module, a comparison module, a backup power supply determining module, and a switching module. The method and system are able to ensure the reliable and optimized fast switching of the load on a bus.

### TECHNICAL FIELD

The present invention relates to a method and system for switching a load on a bus in multiple power sources and, particularly, to a method and system for optimized, reliable and fast switching of a backup power supply in multiple power sources.

### BACKGROUND ART

Currently, devices for fast switching a backup power supply (FBT) can perform switching between two power supplies. FIG. 1 shows a typical example of a solution for a currently available FBT device. During the normal operation of the FBT device, one power supply operates as the main power supply, and the other power supply as a backup power supply. If a system failure occurs in the main power supply, then the FBT devices can switch the load on the bus from the main power supply to the backup power supply in the shortest time, so as to ensure the uninterrupted power supply to the load on the bus.

Furthermore, in the currently available FBT devices, the FBT devices would check the following criteria before initiating a backup power supply switching signal:

(1) V_{diff}<a set value

(2) f_{diff}<a set value

(3) θ_{diff}<a set value

(4) V_{backup}>a set value

wherein:

V_{diff} is the voltage difference between the bus and the backup power supply,

f_{diff} is the frequency difference between the bus and the backup power supply,

θ_{diff} the phase angle difference between the bus and the backup power supply, and

V_{backup} is the voltage of the backup power supply.

After a failure has occurred in the main power supply system, the FBT devices will check these criteria. If the backup power supply meets all the criteria, then the FBT devices will switch the load on the bus from the main power supply to the backup power supply.

During the checking of the above criteria, the conventional FBT devices would assume that the change speeds of V_{diff} and θ_{diff} are two constants, and the users can use these two constants to calculate the set values for V_{diff} and θ_{diff}.

For example, if the maximum allowable value of θ_{diff} is 66°, the assumed change speed of θ_{diff} is 1 Hz, and the inherent closing time of a circuit breaker is 0.1 s, then: the advanced value of θ_{diff} is: 360°×0.1 s×1 Hz=36°.

Therefore, the set value of θ_{diff} should be 66°−36°=30°.

In this way, when θ_{diff} is smaller than 30°, the FBT devices would switch the load on the bus from the main power supply to the backup power supply.

In the currently available devices for fast switching backup power supplies, it is necessary to check the above four criteria (1), (2), (3) and (4) separately, and especially it is still necessary to check the frequency difference f_{diff} between the bus and the backup power supply, however, in practical applications, most of the loads on the bus are rotary loads, therefore, the amplitudes of bus voltages are proportional to the rotors' frequencies. The conventional devices for fast switching backup power supplies have the criteria of V_{diff} and f_{diff} (the two of them are proportional to each other) at the same time, however, in the practical use, this often results in unsuccessful switching due to the issues regarding mutual matching of the users' set values. This has led to the case that many backup power supplies which only meet criteria (1), (3) and (4) are excluded, thereby reducing significantly the probability of successful switching in a fast switching mode, thus it is unable to ensure reliable and optimized fast switching of a load on a bus line.

### CONTENTS OF THE INVENTION

The object of the present invention is to provide a method for fast switching a backup power supply in multiple power sources.

The object is solved by a method, comprising: when a main power supply failure is detected,

1) calculating a current time voltage difference V_{diff} between a bus and a backup power supply and a current time phase angle difference θ_{diff} between the bus and the backup power supply;

2) making a determination that the backup power supply is the one to be switched to only when its V_{diff} is within an allowable voltage difference between the bus and the backup power supply, its θ_{diff} is within an allowable phase angle difference between the bus and the backup power supply, and a current time voltage V_{backup} of the backup power supply is greater than the minimum allowable voltage V_{min backup} of the backup power supply; and

3) initiating a backup power supply switching signal so as to switch the load on the bus to said backup power supply.

Therefore, during a fast switching mode, the load on the bus can be switched fast without checking the frequency difference f_{diff} between the bus and the backup power supply, thus improving the probability of a successful switching in the fast switching mode.

In this case, said multiple power source includes a plurality of backup power supplies, and the method further comprises:

performing steps 1) to 2) above for each backup power supply of the plurality of backup power supplies after having made a determination that the backup power supply is the one to be switched to, and before having initiated the backup power supply switching signal to switch the load on the bus to said backup power supply, so as to determine a number of backup power supplies as the ones to be switched to, and initiating the backup power supply switching signal so as to switch the load on the bus to one of said number of backup power supplies.

Therefore, the load on the bus can be selectively switched to one of the number of auxiliary backup power supplies so as to ensure the reliable and fast switching of the load on the bus.

In this case, the method further comprises:

after having determined the number of backup power supplies as the ones to be switched to, comparing the Vdiff values of the number of backup power supplies so as to determine the backup power supply with the minimum Vdiff as a determined backup power supply, and initiating the backup power supply switching signal to switch the load on the bus to this determined backup power supply.

Therefore, the load on the bus can be switched to an optimum backup power supply in the number of auxiliary backup power supplies, so as to ensure the optimized and fast switching of the load on the bus.

In this case, the allowable voltage difference between the bus and the backup power supply is obtained by calculating V_{diffmax}−V_{advanced}, wherein V_{diffmax} is the maximum allowable voltage difference between the bus and the backup power supply, and V_{advanced} is a forecast advanced voltage difference between the bus and the backup power supply.

In this case, the forecast advanced voltage difference V_{advanced} between the bus and the backup power supply is obtained by calculation according to the following equation:

$${V}_{advanced} Δ V \times Δ T + \frac{1}{2} {( Δ V )}^{′} \times {( Δ T )}^{2} ,$$

wherein ΔV is the current time change speed of V_{diff}, (ΔV)′ is the acceleration of V_{diff}, and ΔT is an inherent closing time.

In this case, the allowable phase angle difference between the bus and the backup power supply is obtained by calculating θ_{diffmax}−θ_{advanced}, wherein θ_{diffmax} is the maximum allowable phase angle difference between the bus and the backup power supply, and θ_{advanced} is the forecast advanced phase angle difference between the bus and the backup power supply.

In this case, the forecast advanced phase angle difference θ_{advanced} between the bus and the backup power supply is obtained by calculation according to the following equation:

$${θ}_{advanced} = ω \times Δ T + \frac{1}{2} {( Δ ω )}^{′} \times {( Δ T )}^{2} ,$$

wherein Δω is the current time change speed of θ_{diff}, (Δω)′ is the acceleration of θ_{diff} and ΔT is the inherent closing time.

The present invention further provides a system for fast switching a backup power supply in multiple power sources, and the system comprises:

a detecting module for detecting a main power supply failure signal in main power supply signals;

a calculating module for receiving said main power supply failure signal, and calculating a current time voltage difference V_{diff} between the bus and the backup power supply and a current time phase angle difference θ_{diff} between the bus and the backup power supply; a comparison module for receiving the V_{diff} and θ_{diff}, and for comparing V_{diff} with an allowable voltage difference between the bus and the backup power supply, the θ_{diff} with an allowable phase angle difference between the bus and the backup power supply, and a current time voltage V_{backup} of the backup power supply with the minimum allowable voltage V_{min backup} of the backup power supply;

a backup power supply determining module for receiving the comparison results from the comparison module, and for making a determination that the backup power supply is the one to be switched to only when its V_{diff} is within the allowable voltage difference between the bus and the backup power supply, its θ_{diff} is within the allowable phase angle difference between the bus and the backup power supply, and the current time voltage V_{backup} of the backup power supply is greater than the minimum allowable voltage V_{min backup} of the backup power supply; and

a switching module for receiving the determination result from the backup power supply determining module, and initiating a backup power supply switching signal so as to switch the load on the bus to said backup power supply.

In this case, said multiple power source includes a plurality of backup power supplies, and the system further comprises:

a selecting module for selecting one of said backup power supplies to be switched to as a determined backup power supply after the backup power supply determining module has determined that said backup power supplies are the backup power supplies to be switched to and before the switching module has initiated the backup power supply switching signal to switch the load on the bus to said backup power supply, and sending the determination result to said switching module to initiate the backup power supply switching signal to switch the load on the bus to said determined backup power supply.

In this case, said selecting module is used for comparing the V_{diff} values of said backup power supplies to be switched to, and making a determination that the backup power supply with the minimum V_{diff} is a determined backup power supply, and sending the determination result to said switching module initiate the backup power supply switching signal so as to switch the load on the bus to this determined backup power supply

In this case, said calculating module further includes a first calculating module, which first calculating module is used for obtaining the allowable voltage difference between the bus and the backup power supply by calculating V_{diffmax}−V_{advanced}, wherein V_{diffmax} is the maximum allowable voltage difference between the bus and the backup power supply, and ̂advanced is a forecast advanced voltage difference between the bus and the backup power supply, and said comparison module further includes a first comparison module, which first comparison module is used for receiving the V_{diff} and V_{advanced}, and comparing the V_{diff} with V_{diffmax}−V_{advanced}.

In this case, said first calculating module is further used for calculating V_{advanced} according to the following equation:

$${V}_{advanced} = Δ V \times Δ T + \frac{1}{2} {( Δ V )}^{′} \times {( Δ T )}^{2} ,$$

wherein ΔV is the current time change speed of V_{diff}, (ΔV)′ i−s the acceleration ∘ V_{diff}, and ΔT is the inherent closing time.

In this case, said calculating module further includes a second calculating module, which second calculating module is used for obtaining the allowable phase angle difference between the bus and the backup power supply by calculating θ_{diffmax}−θ_{advanced}, wherein θ_{diffmax} is the maximum allowable phase angle difference between the bus and the backup power supply and θ_{advanced} is a forecast advanced phase angle difference between the bus and the backup power supply, and said comparison module further includes a second comparison module, which second comparison module is used for receiving the θ_{diff} and θ_{advanced}, and comparing θ_{diff} with θ_{diffmax}−θ_{advanced}.

In this case, said second calculating module is further used for: calculating θ_{advanced} according to the following equation:

$${θ}_{advanced} = Δ ω \times Δ T + \frac{1}{2} {( Δ ω )}^{′} \times {( Δ T )}^{2} ,$$

wherein Δω is the current time change speed of θ_{diff}, (Δω)′ is the acceleration of θ_{diff}, and ΔT is the inherent closing time.

The advantages of the present invention are as follows:

1. it can switch selectively among a plurality of backup power supplies; 2. V_{diff} and θ_{diff} are pre-estimated by using an acceleration model, and whether the conditions for switching are met can be judged without checking f_{diff}, thus improving the probability of successful switching, and ensuring the reliable, optimized and fast switching of a load on a bus.

### BRIEF DESCRIPTION OF THE ACCOMPANYING DRAWINGS

FIG. 1 shows a typical example of a solution in a currently available FBT device;

FIG. 2 is a flow chart of a method for fast switching a backup power supply in multiple power sources according to a first embodiment of the present invention;

FIG. 3 shows an example of a solution for an FBT device of the present invention;

FIG. 4 is a flow chart of a method for fast switching a backup power supply in multiple power sources according to a second embodiment of the present invention;

FIG. 5 is a flow chart of a method for fast switching a backup power supply in multiple power sources according to a third embodiment of the present invention;

FIG. 6 is a schematic structural diagram of the system for fast switching a backup power supply in multiple power sources according to the first embodiment of the present invention; and

FIG. 7 is a schematic structural diagram of the system for fast switching a backup power supply in multiple power sources according to the second embodiment of the present invention.

### EXEMPLARY EMBODIMENTS

For better and clearer understanding of the objects, technical solutions and advantages of the present invention, the present invention will be further described in detail hereinbelow by illustrating embodiments with reference to the accompanying drawings.

The method for fast switching a backup power supply in multiple power sources of the present invention comprises: when a main power supply failure is detected,

1) calculating a current time voltage difference V_{diff} between a bus and a backup power supply and a current time phase angle difference θ_{diff} between the bus and the backup power supply;

2) making a determination that the backup power supply is the one to be switched to only when its V_{diff} is within an allowable voltage difference between the bus and the backup power supply, its θ_{diff} is within an allowable phase angle difference between the bus and the backup power supply, and a current time voltage V_{backup} of the backup power supply is greater than the minimum allowable voltage V_{min backup} of the backup power supply; and

3) initiating a backup power supply switching signal so as to switch the load on the bus to said backup power supply.

In this case, the allowable voltage difference between the bus and the backup power supply can be obtained by calculating V_{diffmax}−V_{advanced}, wherein V_{diffmax} is the maximum allowable voltage difference between the bus and the backup power supply, and V_{advanced} is the forecast advanced voltage difference between the bus and the backup power supply.

The allowable phase angle difference between the bus and the backup power supply can be obtained by calculating θ_{diffmax}−θ_{advanced}′ wherein θ_{diffmax} is the maximum allowable phase angle difference between the bus and the backup power supply, and θ_{advanced} is the forecast advanced phase angle difference between the bus and the backup power supply.

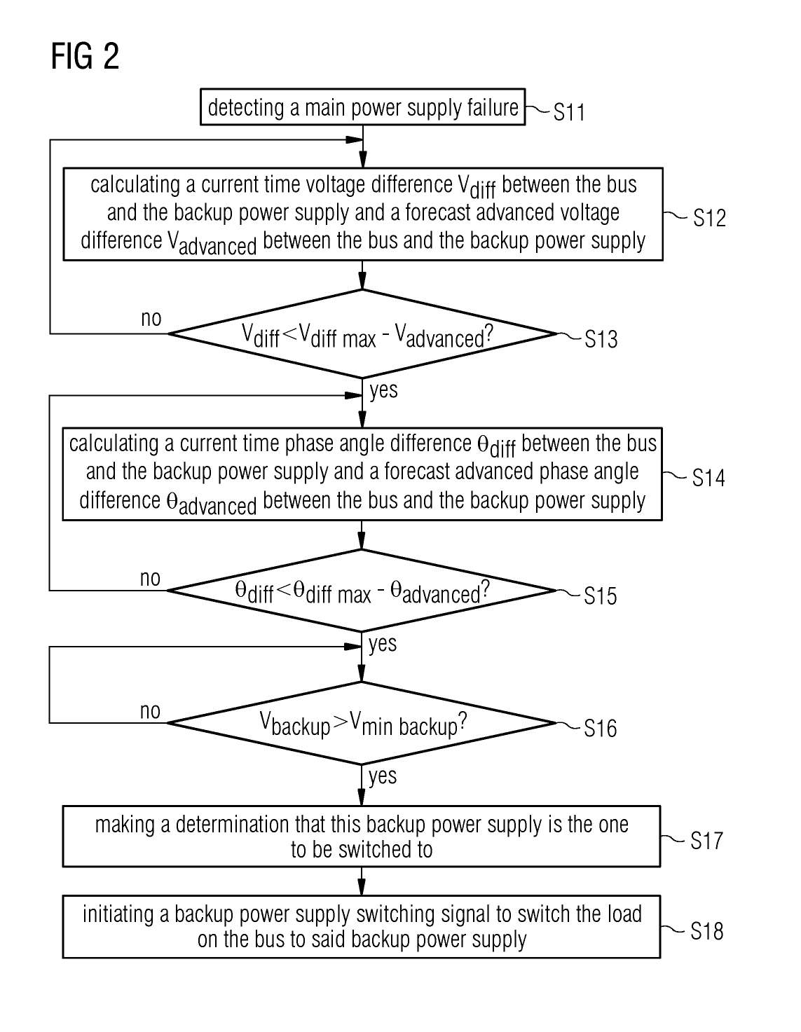

FIG. 2 is a flow chart of a method for fast switching a backup power supply in multiple power sources according to the first embodiment of the present invention; and as shown in FIG. 2, the method for fast switching a backup power supply in multiple power sources of the present invention comprises the steps as follows:

S11: A main power supply failure is detected.

S12: A current time voltage difference V_{diff} between a bus and a backup power supply and a forecast advanced voltage difference V_{advanced} between the bus and the backup power supply are calculated.

S13: The V_{diff} is compared with V_{diffmax}−V_{advanced}.

S14: When V_{diff}<V_{diffmax}−V_{advanced}, a current time phase angle difference 9dlff between the bus and the backup power supply and a forecast advanced phase angle difference 0advanced between the bus and the backup power supply are calculated.

S15: The θ_{diff} is compared with θ_{diffmax}−θ_{advanced}.

S16: When θ_{diff}<θ_{diffmax}−θ_{advanced}, a current time voltage V_{backup} of the backup power supply is compared with the minimum allowable voltage V_{min backup} of the backup power supply.

S17: When V_{backup}>V_{min backup}, ′ a determination is made that the backup power supply is the one to be switched to.

S18: A backup power supply switching signal is initiated so as to switch the load on the bus to said backup power supply.

In this case, the comparisons of V_{diff}<V_{diffmax}−V_{advanced}, θ_{diff}<θ_{diffmax}-eadvanced and V_{backup}>V_{min backup} are not limited to the above order, instead, the comparison of θ_{diff}<θ_{diffmax}−θ_{advanced} can be made first, and then V_{diff}<V_{diffmax}−V_{advanced} and V_{backup}>V_{min backup}, also the comparison of V_{backup}>V_{min backup} can be made first, and then V_{diff}<V_{diffmax}−V_{advanced} and θ_{diff}<θ_{diffmax}−θ_{advanced}, and these comparisons can be performed according to other orders.

In this way, when a failure occurs in the main power supply, during a fast switching mode, the load on the bus can be switched fast by checking only V_{diff}, θ_{diff} and V_{backup}, without checking the frequency difference f_{diff} between the bus and the backup power supply, thus improving the probability of successful switching of the fast switching mode.

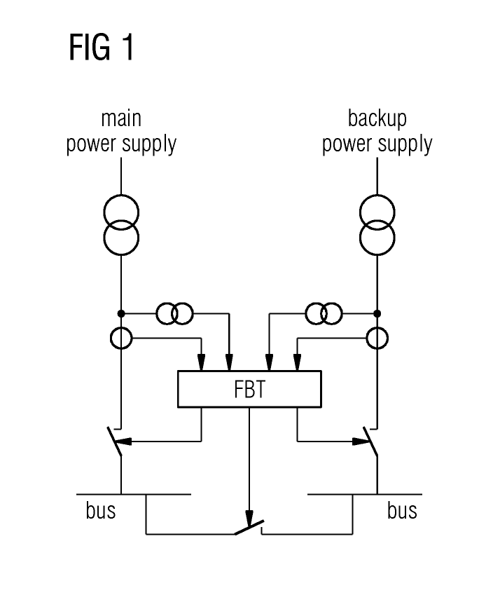

Furthermore, the currently available solution shown in FIG. 1 can only be suitable for the case of a configuration of two power supplies (that is to say, one main power supply and one backup power supply), and such a structure can only switch the main power supply to one backup power supply, so cannot be applied to a plurality of backup power supplies, and is by no means able to select an optimum backup power supply; and besides, if a failure occurs in this backup power supply, the load on the bus will lose its power supply.

Since, in practical applications, most of the loads on the bus are rotary ones, the amplitudes of bus voltages are proportional to the rotor frequencies. That method only sets V_{diff}, but not f_{diff} I so as to be able to prevent effectively any mismatch among the set values by users in the practical applications, causing an error of artificially narrowing the range for switching.

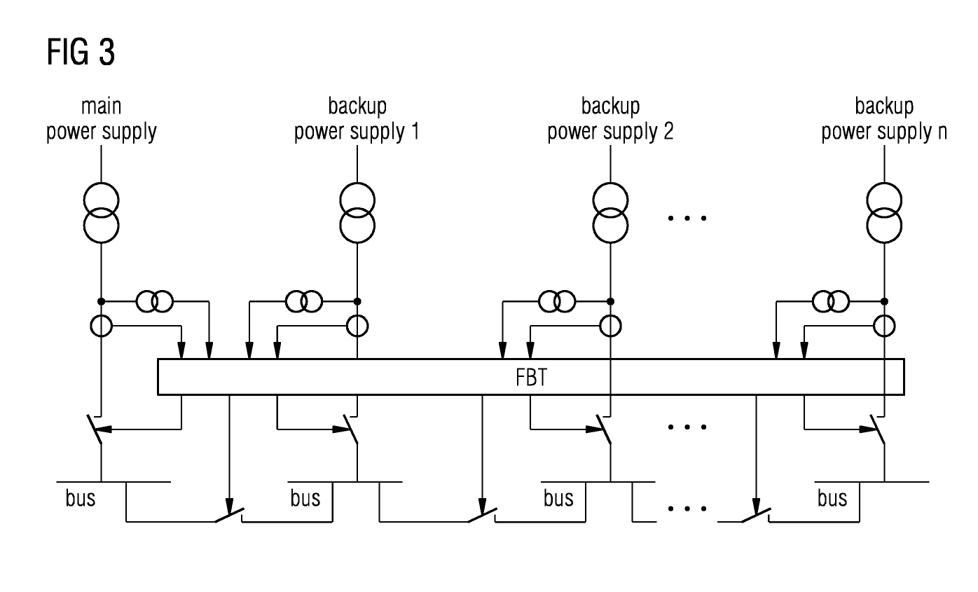

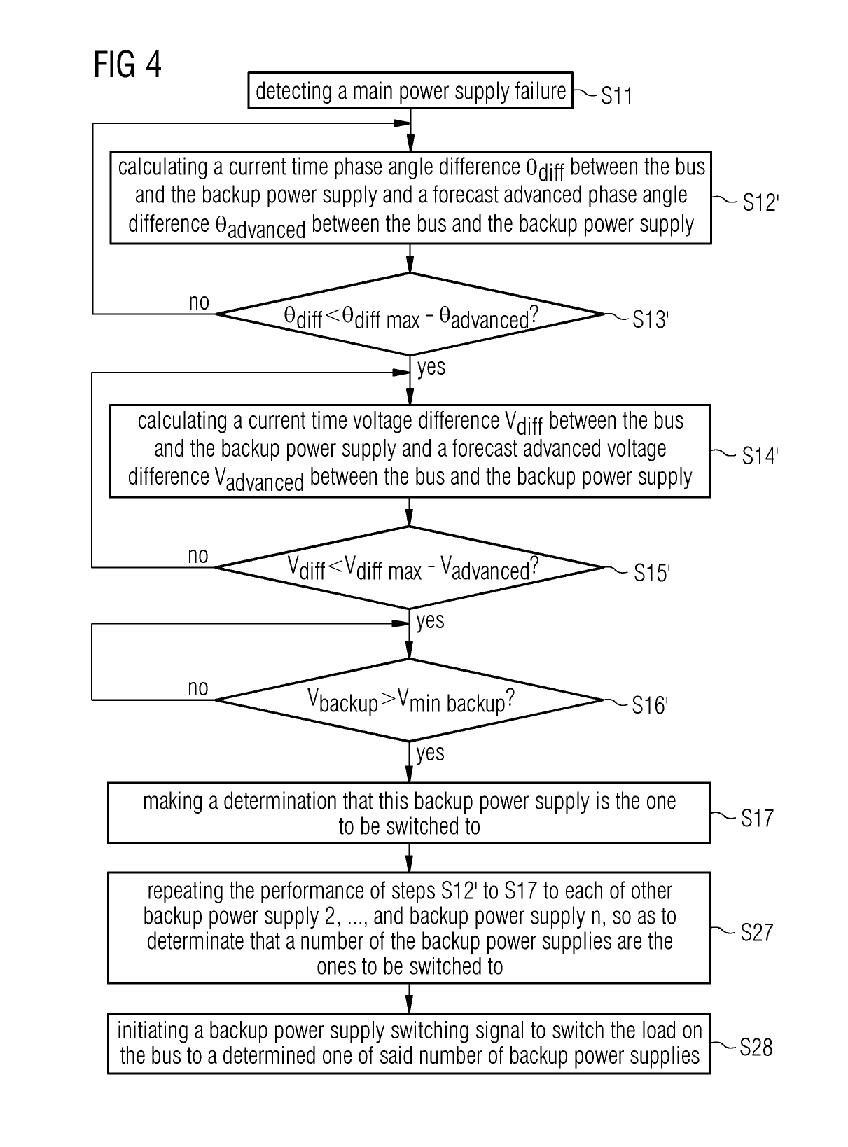

FIG. 3 shows an example of a solution for an FBT device of the present invention, in which said multiple power source includes a main power supply together with a backup power supply 1, a backup power supply 2, and a backup power supply n. In FIG. 3, when a failure occurs in the main power supply, the load on the bus will be switched to one of the backup power supply 1, the backup power supply 2, and the backup power supply n. FIG. 4 is a flow chart of the method for fast switching a backup power supply in multiple power sources according to the second embodiment of the present invention. As shown in FIG. 4, the method for fast switching a backup power supply in multiple power sources of the present invention comprises the steps as follows:

S11: A main power supply failure is detected.

S12′: A current time phase angle difference θ_{diff} between a bus and a backup power supply and a forecast advanced phase angle difference θ_{advanced} between the bus and the backup power supply are calculated.

S13′: The θ_{diff} is compared with θ_{diffmax}−θ_{advanced}.

S14′: When θ_{diff}<θ_{diffmax}−θ_{advanced}, a current time voltage difference V_{diff} between the bus and the backup power supply and a forecast advanced voltage difference V_{advanced} between the bus and the backup power supply are calculated.

S15′: The V_{diff} is compared with V_{diffmax}−V_{advanced}.

S16′: When V_{diff}<V_{diffmax-}V_{advanced}, a current time voltage V_{backup} of the backup power supply is compared with the minimum allowable voltage V_{min backup} of the backup power supply.

S17: When V_{backup}>V_{min backup}, a determination is made that the backup power supply is the one to be switched to.

S27: The above steps S12 to S16 are repeated for each of the other backup power supply 2, and backup power supply n in the plurality of backup power supplies so as to determine a number of backup power supplies among the backup power supply 1, backup power supply 2, and backup power supply n as the ones to be switched to.

S28: A backup power supply switching signal is initiated so as to switch the load on the bus to a determined one in said number of backup power supplies.

In this case, the comparisons of V_{diff}<V_{diffmax-}V_{advanced} and θ_{diff}<θ_{diffmax}−θ_{advanced} are not limited to the above order, instead, V_{diff}<V_{diffmax-}V_{advanced} can be compared first, and then θ_{diff}<θ_{diffmax}−θ_{advanced} and V_{backup}>V_{min backup} can be compared first, and then V_{diff}<V_{diffmax-}V_{advanced} and θ_{diff}<θ_{diffmax}−θ_{advanced} and the comparisons can be performed according to other orders.

In this way, when a failure occurs in the main power supply, the load on the bus can be selectively switched to a determined backup power supply in a number of auxiliary backup power supplies, so as to ensure the reliable and fast switching of the load on the bus.

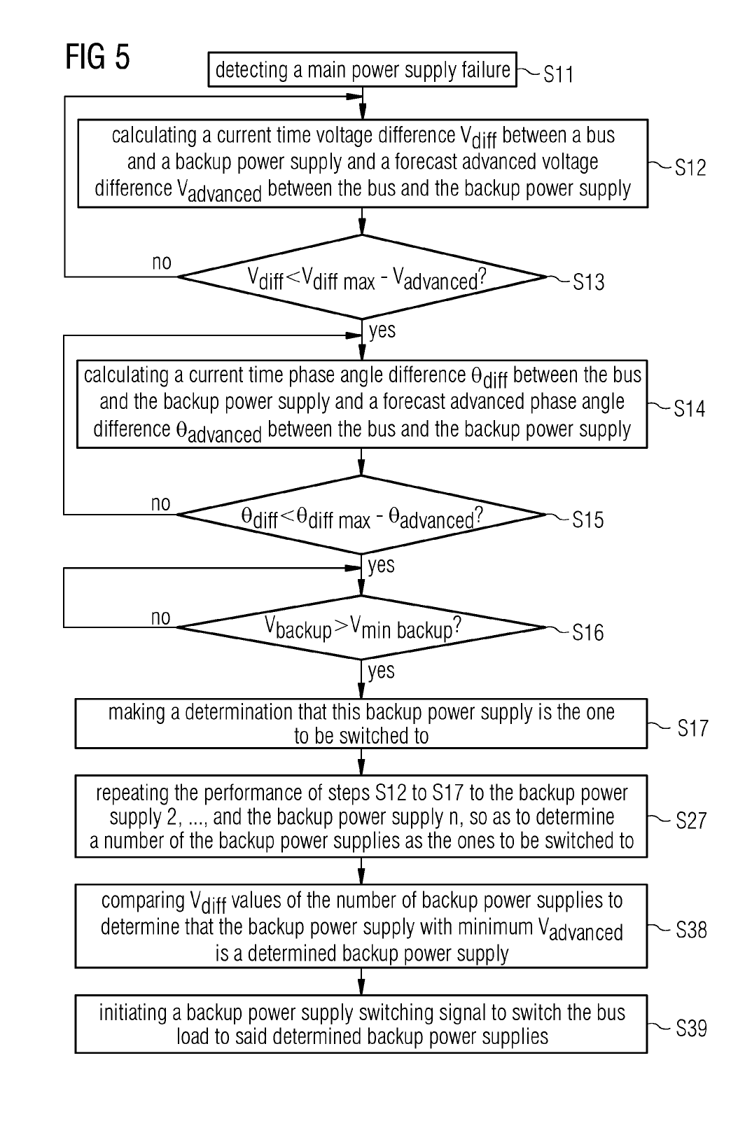

FIG. 5 is a flow chart of a method for fast switching a backup power supply in multiple power sources according to the third embodiment of the present invention. As shown in FIG. 5, compared with the first embodiment shown in FIG. 2, the method for fast switching a backup power supply in multiple power sources according to the present invention further includes, in addition to steps S11 to S16 included, the steps as follows:

S27: The above steps S12 to S16 are repeated to each one of the other backup power supplies 2, and backup power supply n in a plurality of backup power supplies, so as to determine a number of backup power supplies among the backup power supply 1, backup power supply 2, and backup power supply n as the ones to be switched to.

S38: The V_{diff} values of the above plurality of backup power supplies are compared so as to determine that the backup power supply with the minimum V_{diff} is a determined backup power supply, and the backup power supply determined at this moment is the optimum backup power supply.

S39: The backup power supply switching signal is initiated so as to switch the load on the bus to this determined backup power supply.

In this way, when a failure occurs in the main power supply, the load on the bus can be switched to the optimum backup power supply in the number of auxiliary backup power supplies so as to ensure the optimized and fast switching of the load on the bus.

In the above embodiments of the method for fast switching a backup power supply in multiple power sources, V_{diff} is the voltage difference between the bus voltage and the backup power supply voltage measured dynamically by the FBT device, θ_{diff} is the phase angle difference between the bus phase angle and backup power supply phase angle measured dynamically by the FBT device, V_{diffmax} and θ_{diffmax} are set by a user according to the application situation, and Vadvanced and V_{advanced} and θ_{advanced} are forecasted by the FBT device using a dynamical acceleration model.

This method uses an acceleration model to forecast the amplitude of a voltage difference and the attenuation speed of a phase angle, and compared with the conventional methods which use a constant attenuation speed to forecast the amplitude of a voltage difference and the change of a phase angle, this method can forecast their changing characteristics more accurately, thus improving the success rate of the fast switching to a backup power supply when a working power supply has failed.

Preferably, in the above method for fast switching a backup power supply in multiple power sources, calculating the forecast advanced voltage difference V_{advanced} between the bus and the backup power supply in steps S12 and S14′ further includes: calculating V_{advanced} according to the following equation:

$${V}_{advanced} = Δ V \times Δ T + \frac{1}{2} {( Δ V )}^{′} \times {( Δ T )}^{2} ,$$

wherein ΔV is the current time change speed of V_{diff}, (ΔV)′ is the acceleration of V_{diff}, and ΔT is an inherent closing time.

Preferably, in the above method for fast switching a backup power supply in multiple power sources, calculating the forecast advanced phase angle difference 0ADVANCED between the bus and the backup power supply in steps S13 and S12′ further includes: calculating θ_{advanced} according to the following equation:

$${θ}_{advanced} = Δ ω \times Δ T + \frac{1}{2} {( Δ ω )}^{′} \times {( Δ T )}^{2} ,$$

wherein Δω is the current time change speed of θ_{diff}, (Δω)′ is the acceleration of θ_{diff}, and ΔT is the inherent closing time.

The system for fast switching a backup power supply in multiple power sources (FBT) of the present invention comprises:

a detecting module for detecting a main power supply failure signal in main power supply signals;

a calculating module for receiving said main power supply failure signal, and calculating a current time voltage difference V_{diff} between the bus and a backup power supply and a current time phase angle difference θ_{diff} between the bus and the backup power supply;

a comparison module for receiving the V_{diff} and θ_{diff}, and for comparing V_{diff} with an allowable voltage difference between the bus and the backup power supply, θ_{diff} with an allowable phase angle difference between the bus and the backup power supply, and a current time voltage Vbackup of the backup power supply with the minimum allowable voltage V_{minbackup} of the backup power supply;

a backup power supply determining module for receiving the comparison results from the comparison module, and making a determination that the backup power supply is the one to be switched to only when its V_{diff} is within the allowable voltage difference between the bus and the backup power supply, its θ_{diff} is within the allowable phase angle difference between the bus and the backup power supply, and the current time voltage of the backup power supply V_{backup} is greater than the minimum allowable voltage V_{minbackup} of the backup power supply; and a switching module for receiving the determination result from the backup power supply determining module, and initiating a backup power supply switching signal so as to switch the load on the bus to said backup power supply.

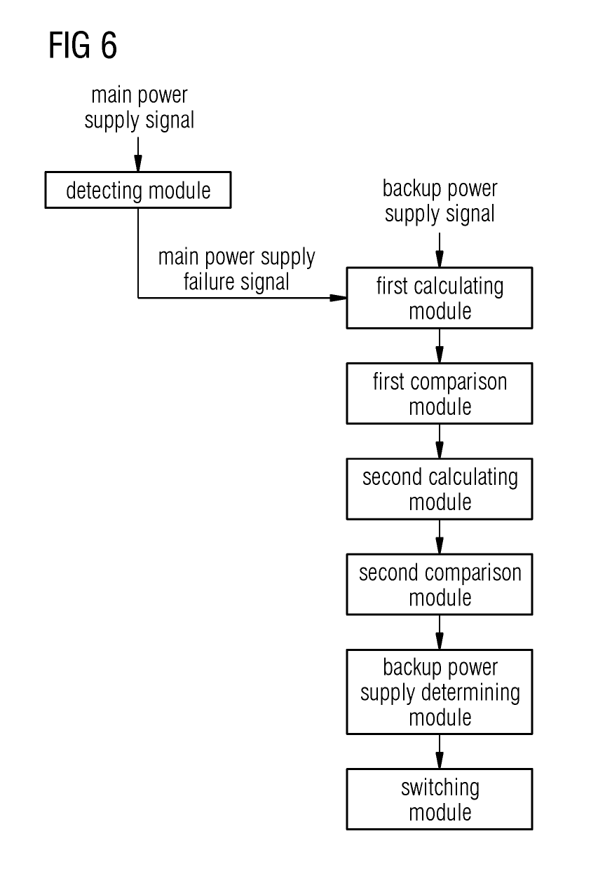

FIG. 6 is a schematic structural diagram of a system for fast switching a backup power supply in multiple power sources (FBT) according to the first embodiment of the present invention. As shown in FIG. 6, the system for fast switching a backup power supply in multiple power sources of the present invention includes:

a detecting module for detecting a main power supply failure signal in main power supply signals;

a first calculating module for receiving said main power supply failure signal, and calculating a current time voltage difference V_{diff} between the bus and the backup power supply and a forecast advanced voltage difference V_{advanced} between the bus and the backup power supply;

a first comparison module for receiving the V_{diff} and V_{advanced}, and comparing the V_{diff} with max wherein max is the maximum allowable voltage difference between the bus and the backup power supply;

a second calculating module for receiving the comparison result from the first comparison module, and calculating a current time phase angle difference θ_{diff} between the bus and the backup power supply and a forecast advanced voltage difference θ_{advanced} between the bus and the backup power supply when V_{diff}<V_{diffmax-}V_{advanced};

a second comparison module for receiving the θ_{diff} and and comparing θ_{diff} with θ_{diffmax}−θ_{advanced} wherein θ_{diffmax} is the maximum allowable phase angle difference between the bus and the backup power supply;

a backup power supply determining module for receiving the comparison result from the second comparison module, and making a determination that this backup power supply is the one to be switched when θ_{diff}<θ_{diffmax}−θ_{advanced}; and

a switching module for receiving the determination result from the backup power supply determining module, and

initiating a backup power supply switching signal so as to switch the load on the bus to said backup power supply.

As shown in FIG. 3, said multiple power source include a main power supply and a backup power supply 1, a backup power supply 2, and a backup power supply n. When a failure occurs in the main power supply in FIG. 3, the load on the bus will be switched to one of the backup power supply 1, backup power supply 2, and backup power supply n.

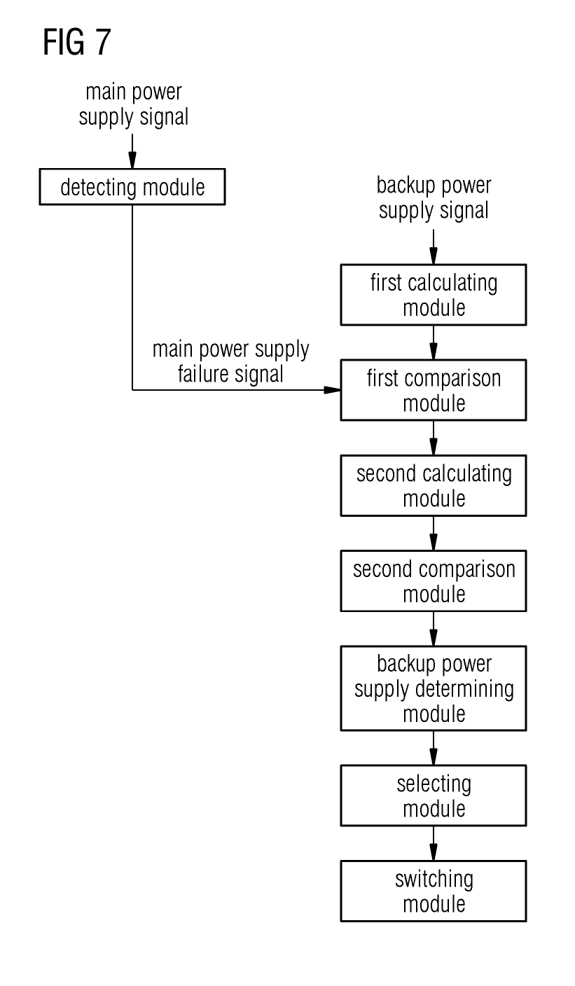

FIG. 7 is a schematic structural diagram of a system for fast switching a backup power supply in multiple power sources (FBT) according to the second embodiment of the present invention. As shown in FIG. 7, compared with the first embodiment shown in FIG. 6, the system for fast switching a backup power supply in multiple power sources of the present invention further comprises: a selecting module for selecting, after the backup power supply determining module has determined said backup power supply as the one to be switched to and before the switching module has initiated the backup power supply switching signal to switch the load on the bus to said backup power supply, one of said backup power supplies to be switched to as a determined backup power supply, and sending the determination result to said switching module to initiate the backup power supply switching signal so as to switch the load on the bus to said determined backup power supply. For example, in the case that the selecting module selects the backup power supply 2 (as shown in FIG. 3) as the determined backup power supply, the switching module switches the load on the bus to the backup power supply 2 according to the determination result.

Compared with the second embodiment, in the third embodiment of the system for fast switching a backup power supply in multiple power sources of the present invention, said selecting module is further used for comparing the V_{diff} values of said backup power supplies to be switched to, and making a determination that the backup power source with the minimum V_{diff} is the determined backup power supply (at this moment, the determined backup power supply is the optimum backup power supply), and sending the determination result to said switching module to initiate the backup power supply switching signal so as to switch the load on the bus to this determined backup power supply.

In the above embodiments of the system for fast switching a backup power supply in multiple power sources, V_{diff} is the voltage difference between the bus voltage and the backup power supply voltage measured dynamically by the FBT device, θ_{diff} is the phase angle difference between the bus phase angle and backup power supply phase angle measured dynamically by the FBT device, V_{diffmax} and θ_{diffmax} are set by −1 a user according −1 to their application situations, V_{advanced} and θ_{advanced} are forecasted by the FBT device using a dynamical acceleration model, wherein the change speeds ΔV and Δω of V_{diff} and θ_{diff} are different in different application situations so as to reflect the load on the bus which changes all the time.

Preferably, in the above system for fast switching a backup power supply in multiple power sources, said first calculating module is further used for calculating V_{advanced} according to the following equation:

$${V}_{advanced} = Δ V \times Δ T + \frac{1}{2} {( Δ V )}^{′} \times {( Δ T )}^{2} ,$$

wherein ΔV is the current time change speed of V_{diff}, (ΔV)′ is the acceleration of V_{diff}, and ΔT is an inherent closing time.

Preferably, in the above system for fast switching a backup power supply in multiple power sources, said second calculating module is further used for calculating θ_{advanced} according to the following equation:

$${θ}_{advanced} = Δ ω \times Δ T + \frac{1}{2} {( Δ ω )}^{′} \times {( Δ T )}^{2} ,$$

wherein Δω is the current time change speed of θ_{diff}, (Δω)′ is the acceleration of θ_{diff}, and ΔT is the inherent closing time.

It can be seen that the in method and system for fast switching a backup power supply in multiple power sources according to the embodiments of the present invention, there is no need to check f_{diff} during fast switching mode, thus greatly improving the successful switch rate of fast switching mode.

Also, the method and system for fast switching a backup power supply in multiple power sources according to the embodiments of the present invention can switch the load on the bus to a plurality of backup power supplies so as to ensure the reliable and fast switching of the load on a bus, thereby significantly improving the stability of its power supply.

Furthermore, in the method and system for fast switching a backup power supply in multiple power sources according to the embodiments of the present invention, switching the load on the bus to the optimum backup power supply with the minimum V_{diff} by comparing V_{diff} can achieve the optimized switching of the load on a bus.

What are mentioned above are merely the preferred embodiments of the present invention, and they are not intended to limit the protection scope of the present invention. Any modifications, equivalent substitutions and improvements within the spirit and principle of the present invention are to be covered in the protection scope of the present invention.

1-14. (canceled)

15. A method for fast switching a backup power supply of a multiple power source, which when a failure is detected in a main power supply, comprises the steps of:
1) calculating a current time voltage difference V_{diff} between a bus and a backup power supply and calculating a current time phase angle difference θ_{diff} between the bus and the backup power supply;
2) making a determination that the backup power supply is to be switched to only when the current time voltage difference V_{diff} is within an allowable voltage difference between the bus and the backup power supply, when the current time phase angle difference θ_{diff} is within an allowable phase angle difference between the bus and the backup power supply, and when a current time voltage V_{backup} of the backup power supply is greater than a minimum allowable voltage V_{min backup} for the backup power supply; and
3) initiating a backup power supply switching signal so as to switch a load on the bus to the backup power supply.

16. The method according to claim 15, wherein the multiple power source contains a plurality of backup power supplies, and the method further comprises:
performing steps 1) to 2) above to each of the backup power supplies in the plurality of backup power supplies after making a determination that the backup power supply is the one to be switched to and before initiating the backup power supply switching signal so as to switch the load on the bus to the backup power supply, so as to determine a number of backup power supplies as the ones to be switched to; and
initiating the backup power supply switching signal so as to switch the load on the bus to one of the number of the backup power supplies.

17. The method according to claim 16, wherein after having determined the number of backup power supplies as the ones to be switched to, comparing the current time voltage difference V_{diff} values of the number of the backup power supplies so as to determine which one of the backup power supplies has a minimum V_{diff} value as a determined backup power supply, and initiating the backup power supply switching signal to switch the load on the bus to the determined backup power supply.

18. The method according to claim 15, which further comprises obtaining the allowable voltage difference between the bus and the backup power supply by calculating V_{diffmax}−V_{advanced}, wherein V_{diffmax} is a maximum allowable voltage difference between the bus and the backup power supply and V_{advanced} is a forecast advanced voltage difference between the bus and the backup power supply.

19. The method according to claim 18, which further comprises obtaining the forecast advanced voltage difference V_{advanced} between the bus and the backup power supply by calculation according to the following equation:
$${V}_{advanced} = Δ V \times Δ T + \frac{1}{2} {( Δ V )}^{′} \times {( Δ T )}^{2} ,$$
wherein:
ΔV is a current time change speed of V_{diff};
(ΔV)′ is an acceleration of V_{diff}; and
ΔT is an inherent closing time.

20. The method according to claim 15, which further comprises obtaining the allowable phase angle difference between the bus and the backup power supply by calculating θ_{diffmax}−θ_{advanced}, wherein θ_{diffmax} is a maximum allowable voltage difference between the bus and the backup power supply and θ_{advanced} is a forecast advanced voltage difference between the bus and the backup power supply.

21. The method according to claim 20, which further comprises obtaining the forecast advanced phase angle difference θ_{advanced} between the bus and the backup power supply by calculation according to the following equation:
$${θ}_{advanced} = Δ ω \times Δ T + \frac{1}{2} {( Δ ω )}^{′} \times {( Δ T )}^{2} ;$$
wherein:
Δω is a current time change speed of θ_{diff};
(Δω)′ is an acceleration of θ_{diff}; and
ΔT is an inherent closing time.

22. A system for fast switching a backup power supply in a multiple power source, the system comprising:
a detecting module for detecting a main power supply failure signal in main power supply signals;
a calculating module for receiving the main power supply failure signal, for calculating a current time voltage difference V_{diff} between a bus and a backup power supply and for calculating a current time phase angle difference θ_{diff} between the bus and the backup power supply;
a comparison module for receiving the current time voltage difference V_{diff} and the current time phase angle difference θ_{diff}, for comparing the current time phase angle difference V_{diff} with an allowable voltage difference between the bus and the backup power supply, for comparing the current time phase angle difference θ_{diff} with an allowable phase angle difference between the bus and the backup power supply, and for comparing a current time voltage V_{backup} of the backup power supply with a minimum allowable voltage V_{min backup} of the backup power supply;
a backup power supply determining module for receiving comparison results from said comparison module, for making a determination that the backup power supply is the one to be switched to only when the current time voltage difference V_{diff} is within the allowable voltage difference between the bus and the backup power supply, for determining the current time phase angle difference θ_{diff} is within the allowable phase angle difference between the bus and the backup power supply, and for determining the current time voltage of the backup power supply V_{backup} is greater than a minimum allowable voltage V_{min backup} of the backup power supply; and
a switching module for receiving determined result from said backup power supply determining module, and for initiating a backup power supply switching signal so as to switch a load on the bus to the backup power supply.

23. The system according to claim 22, wherein the multiple power source contains a plurality of backup power supplies, and the system further comprising:
a selecting module for selecting one of said backup power supplies to be switched to as a determined backup power supply after said backup power supply determining module has determined that the backup power supply is the one to be switched to and before said switching module has initiated the backup power supply switching signal to switch the load on the bus to the backup power supply, and sending a determination result to said switching module to initiate the backup power supply switching signal, so as to switch the load on the bus to the determined backup power supply.

24. The system according to claim 23, wherein said selecting module is used for comparing the current time voltage difference V_{diff} of said backup power supply to be switched to, and making a determination that the backup power supply with a minimum V_{diff} is the determined backup power supply, and sending the determination result to said switching module to initiate the backup power supply switching signal, so as to switch the load on the bus to the determined backup power supply.

25. The system according to claim 22, wherein:
said calculating module further includes a first calculating module, said first calculating module is used for obtaining the allowable voltage difference between the bus and the backup power supply by calculating V_{diffmax}−V_{advanced}, wherein V_{diffmax} is a maximum allowable voltage difference between the bus and the backup power supply' and V_{advanced} is a forecast advanced voltage difference between the bus and the backup power supply; and
said comparison module further includes a first comparison module, said first comparison module is used for receiving the current time voltage difference V_{diff} and the V_{advanced}, and comparing the current time voltage difference V_{diff} with V_{diffmax}−V_{advanced}.

26. The system according to claim 25, wherein said first calculating module is further used for calculating the V_{advanced} according to the following equation:
$${V}_{advanced} = Δ V \times Δ T + \frac{1}{2} {( Δ V )}^{′} \times {( Δ T )}^{2} ;$$
wherein:
ΔV is a current time change speed of V_{diff};
(ΔV)′ is an acceleration of V_{diff}; and
T is an inherent closing time.

27. The system according to claim 22, wherein:
said calculating module further includes a second calculating module, aid second calculating module is used for obtaining the allowable phase angle difference between the bus and the backup power supply by calculating θ_{diffmax}−θadvanced, wherein θ_{diffmax} is a maximum allowable voltage difference between the bus and the backup power supply and θ_{advanced} is a forecast advanced voltage difference between the bus and the backup power supply; and
said comparison module further includes a second comparison module, said second comparison module is used for receiving the current time phase angle difference θ_{diff} and the θ_{advanced} and comparing the current time phase angle difference θ_{diff} with the θ_{diffmax}−θ_{advanced}.

28. The system according to claim 27, wherein said second calculating module is further used for calculating the θ_{advanced} according to the following equation:
$${θ}_{advanced} = Δ ω \times Δ T + \frac{1}{2} {( Δ ω )}^{′} \times {( Δ T )}^{2} ,$$
wherein:
Δω is a current time change speed of θ_{diff};
(Δω)′ is an acceleration of θ_{diff}; and
ΔT is the inherent closing time.
